(19) United States
(12) Patent Application Publication
(10) Pub. No.: US 2012/0221479 A1
(43) Pub. Date: Aug. 30, 2012

(54) Web site, system and method for publishing authenticated reviews

(76) Inventors: Philip W. Schneck, III, Washington, DC (US); Frederic W. Malek, Washington, DC (US)

(21) Appl. No.: 12/932,483

(22) Filed: Feb. 25, 2011

(51) Int. Cl. G06Q 30/00

(52) U.S. Cl. 705/347

(57) ABSTRACT

The present invention provides a system and method for authenticating and publishing reviews of service providers. In particular, a third-party website receives information from a reviewer pertaining to a prior purchase and receipt of services from a service provider by the reviewer, and queries a database of the service provider to confirm that the information corresponds to a prior purchase in the database. If the information provided by the reviewer matches the service provider database, the review is accepted and posted online. If the information provided by the reviewer does not match the service provider database, the review is rejected and not published.

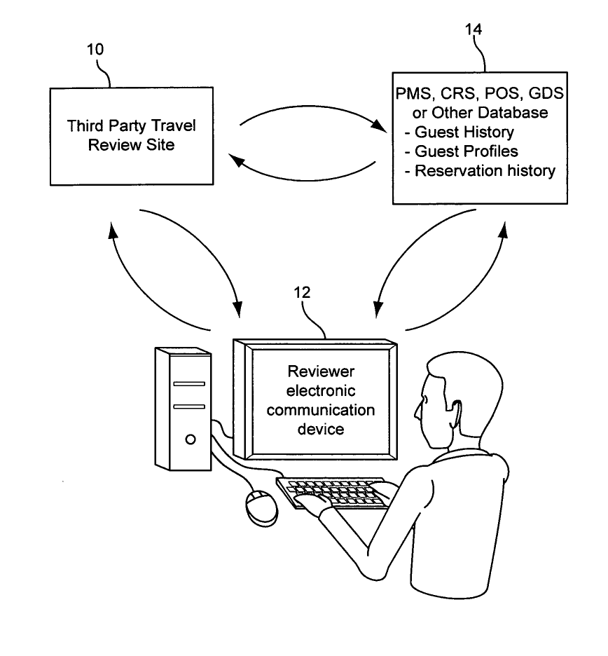

### FIELD OF THE INVENTION

The present invention relates to an authenticating and publishing system and method which enable a customer review website to authenticate that a customer posting a review of a product or service has actually purchased the product or service. More particularly, the invention relates to authenticating and publishing reviews of travel-related service providers and services, such as hotels, airlines, car rental services, spas, golf courses, restaurants, theme parks, cruise lines, time shares, vacation rentals, and local activities or attractions.

### BACKGROUND OF THE INVENTION

Consumer reviews of products and services are an increasingly popular source of information for other consumers in making purchasing decisions. In particular, online reviews of travel-related service providers by customers have a significant impact on the selection or rejection of those service providers by subsequent customers or potential customers prior to making a reservation or purchase of services. For example, websites such as TripAdvisor.com and Yelp.com publish reviews by guests at hotels or restaurants. Positive reviews benefit the reviewed service provider and harm its competitors, negative reviews harm the reviewed service provider and benefit its competitors, and both positive and negative reviews benefit the host websites by attracting site visitors and thus increasing advertising revenue. In addition, online search engines such as Google®, Yahoo® and Bing® use abbreviated third-party guest reviews posted on such websites as part of the results provided to users searching for service providers in a particular location. These abbreviated reviews link to the websites where the full reviews are posted, thereby funneling users to those websites.

According to PhoCusWright Inc., 27 percent of travelers post reviews online about a travel-related product or service. According to a recent MSNBC poll, 86% of respondents indicated that they rely on TripAdvisor.com and other travel sites to gauge traveler sentiment before they make their lodging choice. An internet research study by the Nielson Company reports the top trusted sources for travelers as (1) friends and relatives, (2) newspapers, and (3) online travel review sites.

However, it has become obvious that many reviewers abuse travel review websites by posting fraudulent reviews. For example, someone affiliated with a service provider may post a glowing review pretending to be a customer, thereby fraudulently attracting actual customers to the service provider. Conversely, a competitor or someone with a grudge against a service provider may post a scathing review pretending to be a dissatisfied customer, thereby fraudulently repelling actual potential customers from the service provider. In either case, service providers are either harmed or unjustly benefited, and consumers relying on the fraudulent information are also harmed.

A need therefore exists for a third-party website that authenticates that a reviewer is a bona-fide customer of a service provider before accepting and posting a review of the service provider by the reviewer.

### BRIEF SUMMARY OF THE INVENTION

In accordance with one aspect of the present invention, a method of authenticating and publishing reviews of a product, a service, or a product or service provider is provided. The subject of the review may for example be a travel-related service or service provider such as a hotel (or other lodging provider), an airline, a car-rental service, a spa, a golf course, a restaurant, a cruise line, a theme park, a time share, a vacation rental, or a local activity or attraction. The method includes operating with a host computer/web server a third-party review website for receiving, authenticating, and publishing reviews. It should be noted that the third-party review website need not be strictly dedicated to authenticating and publishing reviews; rather, it is fully within the scope of the invention to integrate a review authenticating and publishing application into an existing neutral third-party website with another primary purpose, as in, for example, a news website. Thus, where the terms “third-party website” and “website” are used herein, they refer to any website incorporating an application performing functions according to the system and method of the invention, regardless of the website's primary purpose. In addition, the invention is directed not only to a website operated by a host computer, but also to an application contained in a computer-readable medium containing instructions for the host computer to perform the aforesaid functions.

The website receives a review of a service provider submitted to the website from a reviewer electronic communication device together with authenticating information from the reviewer device pertaining to an alleged prior purchase of a service from the service provider by the reviewer. The information may include personal information pertaining to the reviewer, such as the reviewer's name, email address and/or loyalty program account number or code with a product or service provider, and information pertaining to the services purchased and provided, such as the dates of usage of the services. Then, the host computer sends a query to a database of the service provider containing information of the same type as the authenticating information, pertaining to actual prior purchases and provision of services. For example, the database may store information requested from and provided by a customer when the customer makes a reservation with the service provider. The information may be transmitted from the customer to the database directly from a communication device (which may or may not be the same device as the reviewer device) when making a reservation, by the customer speaking the information to a reservation or sales agent of the provider who then enters the information in the database, or by any other suitable means. A response from the service provider database to the host computer indicates whether the authenticating information corresponds to an actual prior purchase in the database. If the response indicates that the authenticating information corresponds to an actual prior purchase, the host computer accepts the review and publishes the review on the website, either anonymously or identifying the reviewer by name or by an arbitrary or user-selected ID. If the response indicates no match of the authenticating information to information in the database, the host computer rejects and does not publish the review.

In accordance with another aspect of the present invention, a system is provided for authenticating and publishing reviews of a service provider. The system includes a host computer operating a third-party review website and a computer readable medium containing instructions for the host computer to perform the functions substantially as in the method described above.

In one embodiment, besides facilitating the authenticating and posting of textual reviews, the website may advantageously provide the additional option of posting user-generated audio-visual media, including photography, sound recordings, and video recordings.

In another embodiment, the website may have additional features to supplement its customer-review functions. For example, the website may also provide a medium for service providers such as hotels to promote specials and packages and/or permit service providers to provide their regular customers who are users of the website with brand-loyalty program ID badges associated with their name or user ID on the website.

In still another embodiment, the website also interfaces with recommendation or social-networking functions of another third-party website, such as Facebook “like” buttons or Twitter feeds.

### BRIEF DESCRIPTION OF THE DRAWING

The accompanying FIGURE is a schematic representation of a review authentication and publication system and method in accordance with the invention.

### DETAILED DESCRIPTION OF THE INVENTION

With reference to the accompanying FIGURE, a website, system and method for publishing authenticated reviews of product or service providers is described in this section, whereby only reviews by actual customers of the product or service providers are published on a third-party website.

As shown in the FIGURE, a review authentication and publication system and method involves data transfer among multiple entities, as represented schematically by arrows. In particular, a host computer/web server operating a third-party website 10, website 10 being configured to send and receive data to and from an electronic communication device 12 of a reviewer, which may be a computer with an internet connection, a web-enabled mobile device such as a smart phone, or any other suitable device for transmitting data over the internet, and a database 14 of a product or service provider. The arrows connecting reviewer device 12 to database 14 indicate transfer of data between the reviewer and database 14 pertaining to the reviewer's reservation and/or purchase of a product or service from the provider, which may typically be via device 12, but may be by any other typical means, including but not limited to a telephone or face-to-face conversation of the reviewer with an agent of the provider, who then inputs data verifying the transaction into database 14. For purposes of the invention, it does not matter how database 14 receives authenticating information from a customer.

The present system and method are not limited in scope to authenticating and publishing reviews of only a particular type of product or service provider. However, the invention is particularly beneficial in the context of travel-related services and service providers, including but not limited to hotels (and other lodging), airlines, rental cars, spas, golf courses, restaurants, theme parks, cruise lines, time shares, vacation rentals, and local activities or attractions, as consumers of these services rely heavily on customer reviews in making their purchasing decisions.

In accordance with a method of the invention, a review is submitted from reviewer device 12 to website 10 together with authentication information pertaining to the reviewer and/or the service that the reviewer allegedly purchased from the service provider. The review is authenticated by website 10 communicating directly with one or more of a property management system (PMS), a central reservation system (CRS), a point-of-sale system (POS), a global distribution system (GDS) and/or other systems of the service provider operating one or more databases that store customer history, reservation activity, and/or other information pertaining to the sale and provision of services by the service provider. For ease and brevity of reference, stored records of information of a particular service provider and any hardware and systems that operate or maintain the records are collectively referred to by the term “database” or “database 14” as used herein. The information stored in database 14 may include, for example, the name of the customer, the customer's email address, the customer's loyalty program account number/code, if any, and the date or dates of the customer's usage of the services being reviewed. Where the service provider is a hotel, relevant dates may be the dates of a guest's stay. Before a review is posted, website 10 sends a standardized web services call or query directly to database 14 to confirm via the appropriate records that the reviewer actually purchased and used the product or service being reviewed. Query results are then sent back to website 10 from database 14. If the query matches the reviewer name, email address, loyalty program account number/code, dates of stay or usage, and or other authenticating information with the appropriate records in database 14, then the review is published live on website 10 and listed on website 10 as authenticated. If the query does not match the reviewer with the appropriate records in database 14, the review is rejected and not posted on website 10.

One skilled in the art will understand that the technical details of carrying out the authentication and publication of reviews may vary widely within the scope of the invention. However, in one embodiment, website 10 sends an HTTP post via the host computer/web server to database 14 with the appropriate authentication information, such as customer name, email address, loyalty program account number/code, if any, and date(s) of usage. Through an application programming interface (“API”), which may be a simple-object access protocol (“SOAP”) request, an extensible markup language remote procedure call (“XML-RPC”) request, or representational state transfer (“REST”) request, the appropriate system component of database 14 searches the appropriate records in database 14 for the authentication information. Next, database 14 sends back an HTTP post to the web server/host computer, either confirming or denying the match of the authentication information to the appropriate records in database 14. Upon confirmation or denial, website 10 then either posts the review or denies the review, preferably sending an appropriate message to the reviewer in either case, for example via email. The review may be posted anonymously or indicating the user's real name and/or a user ID selected by the reviewer, which may for example be a sequence of characters or other form of electronic media. The reviewer may be given a choice whether to post anonymously or be identified by name or user ID, or website 10 may limit the reviewer to fewer than all of those options.

In addition to facilitating the authenticating and posting of textual reviews, website 10 may advantageously provide the further option of posting user-generated audio-visual media, including photography, sound recordings, and video recordings. Moreover, website 10 may have additional features to supplement its customer-review functions. For example, website 10 may also provide a medium for service providers such as hotels to promote specials and packages, thus creating a one-stop source for comparing both customer feedback and pricing information for multiple service providers. Where reviewers are identified by name or user ID, website 10 may also permit service providers to provide their regular customers who are users of website 10 with brand-loyalty program ID badges, to increase authenticity of reviews posted by users with the badges and to promote membership in brand-loyalty programs via the presence of users with the badges on website 10. In another embodiment, website 10 also interfaces with recommendation functions of another third-party website. For example, Facebook “like” buttons may be embedded into a graphical user interface of website 10 and/or a Facebook specific application may be provided to link Facebook users to the content and functionality of website 10 from their home pages. Other social networking functions may also be incorporated into website 10, such as linked or embedded Twitter feeds of or associated with service providers.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims:

What is claimed is:

1. A method of authenticating and publishing reviews of a product or service provider comprising:
operating a third-party review website on a host computer;
receiving a review of the provider submitted to the website from a reviewer electronic communication device;
receiving in the host computer authenticating information from the reviewer device pertaining to an alleged prior purchase of a product or service from the provider by the reviewer;
sending from the host computer a query to a database of the service provider containing information pertaining to prior purchases of products or services from the provider;
receiving in the host computer a response from the service provider database indicating whether the authenticating information corresponds to information in the database pertaining to an actual prior purchase; and
only if the response indicates that the authenticating information corresponds to an actual prior purchase, accepting and publishing the review on the website with the host computer.

2. The method of claim 1, the receiving authenticating information including receiving personal information identifying the reviewer and information identifying products or services purchased by the reviewer.

3. The method of claim 2, the personal information including the reviewer's name.

4. The method of claim 2, the personal information including the reviewer's email address.

5. The method of claim 2, the personal information including a code identifying a provider loyalty program account of the reviewer.

6. The method of claim 2, the information identifying products or services purchased including a time period during which the products or services were provided.

7. The method of claim 1, the service provider being a travel-related service provider selected from the group consisting of a hotel, an airline, a car-rental service, a spa, a golf course, a restaurant, a theme park, a time share or vacation rental service, and a cruise line.

8. The method of claim 1, the authenticating information being information requested by the service provider from a customer during a reservation of services.

9. A system for authenticating and publishing reviews of a product or service provider comprising:
a host computer operating a third-party review website; and
a computer readable medium containing instructions for the host computer to:
receive a review of the provider submitted to the website from a reviewer electronic communication device;
receive authenticating information from the reviewer device pertaining to an alleged prior purchase of a product or service from the provider by the reviewer;
send a query to a database of the provider containing information pertaining to prior purchases of products or services from the provider;
receive in the host computer a response from the provider database indicating whether the authenticating information corresponds to information in the database pertaining to an actual prior purchase; and
accept and publish the review on the website only if the response indicates that the authenticating information corresponds to an actual prior purchase.

10. The system of claim 9, the receiving authenticating information including receiving personal information identifying the reviewer and information identifying products or services purchased by the reviewer.

11. The system of claim 10, the personal information including the reviewer's name.

12. The system of claim 10, the personal information including the reviewer's email address.

13. The system of claim 10, the personal information including a code identifying a provider loyalty program account of the reviewer.

14. The system of claim 10, the information identifying products or services purchased including a time period during which the products or services were provided.

15. The system of claim 9, the service provider being a travel-related service provider selected from the group consisting of a hotel, an airline, a car-rental service, a spa, a golf course, a restaurant, a theme park, a time-share or vacation rental service, and a cruise line.

16. The system of claim 9, the authenticating information being information requested by the service provider from a customer during a reservation of services.

17. A computer readable medium containing instructions for a host computer to:
receive a review of the provider submitted to the website from a reviewer electronic communication device;
receive authenticating information from the reviewer device pertaining to an alleged prior purchase of a product or service from the provider by the reviewer;
send a query to a database of the provider containing information pertaining to prior purchases of products or services from the provider;
receive in the host computer a response from the provider database indicating whether the authenticating information corresponds to information in the database pertaining to an actual prior purchase; and
accept and publish the review on the website only if the response indicates that the authenticating information corresponds to an actual prior purchase.
